(19) United States
(12) Patent Application Publication
(10) Pub. No.: US 2022/0309435 A1
(43) Pub. Date: Sep. 29, 2022

(54) INFORMATION PROCESSING APPARATUS, METHOD, AND NON-TRANSITORY COMPUTER READABLE MEDIUM

(71) Applicant: TOYOTA JIDOSHA KABUSHIKI KAISHA, Toyota-shi (JP)

(72) Inventors: Toyokazu NAKASHIMA, Nagoya-shi (JP); Yurika TANAKA, Yokosuka-shi (JP); Shoji SAKAMOTO, Ichikawa-shi (JP); Yusuke KOBAYASHI, Ota-ku (JP); Kotaro OKABE, Ichikawa-shi (JP); Hirotada NAKANISHI, Toyota-shi (JP); Naoya OKA, Nagakute-shi (JP); Daiki OTANI, Nagoya-shi (JP)

(73) Assignee: TOYOTA JIDOSHA KABUSHIKI KAISHA, Toyota-shi (JP)

(21) Appl. No.: 17/674,324

(22) Filed: Feb. 17, 2022

(30) Foreign Application Priority Data
Mar. 25, 2021 (JP) 2021-052361

(51) Int. Cl. G06Q 10/06

(52) U.S. Cl. CPC G06Q 10/06316

(57) ABSTRACT

A controller of an information processing apparatus is configured to, upon acquiring movement information on a vehicle parked in a parking lot, determine whether there is order information for a product or service ordered by a user of the vehicle, and in a case in which there is order information for the product or service, notify, via a communication interface, a provider of the product or service of cancellation information for the product or service.

### CROSS-REFERENCE TO RELATED APPLICATION

This application claims priority to Japanese Patent Application No. 2021-052361, filed on Mar. 25, 2021, the entire contents of which are incorporated herein by reference.

### TECHNICAL FIELD

The present disclosure relates to an information processing apparatus, a method, and a program.

### BACKGROUND

Technology for improving efficiency of operations in stores that provide products or services is known. For example, Patent Literature (PTL) 1 discloses technology in which orders are sorted and provided to a store in order of a preparation start time.

### CITATION LIST

### Patent Literature

PTL 1: JP 2016-071441 A

### SUMMARY

There is room for improvement in technology for improving efficiency of operations in stores that provide products or services.

It would be helpful to improve technology for improving efficiency of operations in stores that provide products or services.

An information processing apparatus according to an embodiment of the present disclosure includes a controller and a communication interface, the controller configured to:

upon acquiring movement information on a vehicle parked in a parking lot, determine whether there is order information for a product or service ordered by a user of the vehicle; and

in a case in which there is order information for the product or service, notify, via the communication interface, a provider of the product or service of cancellation information for the product or service.

A method according to an embodiment of the present disclosure is a method performed by an information processing apparatus, the method including:

upon acquiring movement information on a vehicle parked in a parking lot, determining whether there is order information for a product or service ordered by a user of the vehicle; and in a case in which there is order information for the product or service, notifying a provider of the product or service of cancellation information for the product or the service.

A program according to an embodiment of the present disclosure is configured to cause a computer to execute operations, the operations including:

upon acquiring movement information on a vehicle parked in a parking lot, determining whether there is order information for a product or service ordered by a user of the vehicle; and in a case in which there is order information for the product or service, notifying a provider of the product or service of cancellation information for the product or service.

According to an embodiment of the present disclosure, technology for improving efficiency of operations in stores that provide products or services is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a vehicle according to the embodiment of the present disclosure;

FIG. 3 is a block diagram illustrating a schematic configuration of an information processing apparatus according to the embodiment of the present disclosure;

FIG. 4 is a block diagram illustrating a schematic configuration of a terminal apparatus according to the embodiment of the present disclosure; and

FIG. 5 is a flowchart illustrating operations of the information processing apparatus according to the embodiment of the present disclosure.

### DETAILED DESCRIPTION

Hereinafter, an embodiment of the present disclosure will be described.

### (Outline of Embodiment)

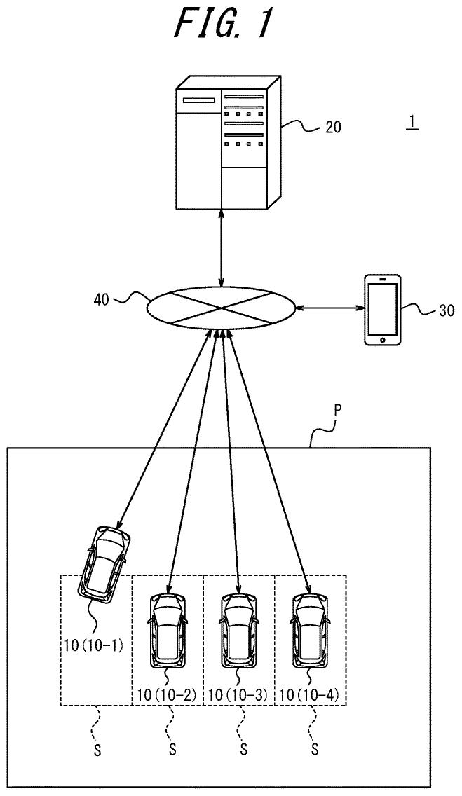

An outline of a system 1 according to an embodiment of the present disclosure will be described with reference to FIG. 1. The system 1 includes a plurality of vehicles 10, an information processing apparatus 20, and a terminal apparatus 30. The vehicles 10, the information processing apparatus 20, and the terminal apparatus 30 are communicably connected to a network 40 including, for example, the Internet, a mobile communication network, and the like.

The plurality of vehicles 10 (in the case of distinguishing each of the plurality of vehicles 10, each of the vehicles 10 is referred to as a vehicle 10-1, a vehicle 10-2, . . . ) are automobiles, for example, but are not limited to these, and may be any vehicles. The automobiles may each be, for example, a gasoline-powered vehicle, a BEV (Battery Electric Vehicle), an HEV (Hybrid Electric Vehicle), a PHEV (Plug-in Hybrid Electric Vehicle), an FCEV (Fuel Cell Electric Vehicle), or the like, but are not limited to these. The vehicles 10 may each be driven by a driver, or the driving may be automated at any level. The level of automation is, for example, one of level 1 to level 5 according to the classification of the Society of Automotive Engineers (SAE). The vehicles 10 may be a dedicated Mobility as a Service (MaaS) vehicles. The number of the vehicles 10 provided in the system 1 may be freely determined.

The information processing apparatus 20 is, for example, a computer such as a server apparatus. The information processing apparatus 20 can communicate with the vehicles 10 via the network 40.

The terminal apparatus 30 is, for example, a general purpose electronic device, such as a smartphone, a tablet, or a personal computer (PC). The terminal apparatus 30 can communicate with the information processing apparatus 20 via the network 40.

First, an outline of the present embodiment will be described, and details thereof will be described later. When a controller 21 of the information processing apparatus 20 acquires movement information on the vehicle 10-1 parked in a parking lot P, the controller 21 determines whether there is order information for a product or service ordered by a user of the vehicle 10-1. In a case in which there is order information for the product or service, the controller 21 of the information processing apparatus 20 notifies, via a communication interface 22, a provider of the product or service of cancellation information for the product or service.

Thus, according to the present embodiment, when the vehicle 10-1 parked in the parking lot P moves, the cancellation information for the product or service that has been ordered by the user of the vehicle 10-1 is notified to the provider of the product or service. This avoids a situation in which a product or service is ordered but there is no recipient of the product or service. Thus, technology for improving efficiency of operations in stores that provide products or services is improved.

Next, configurations of the system 1 will be described in detail.

(Configuration of Vehicle)

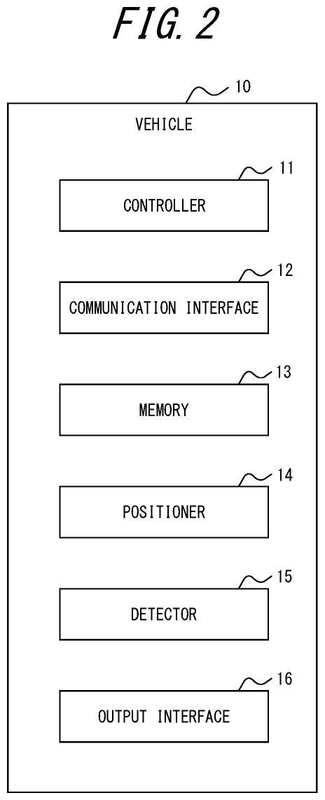

As illustrated in FIG. 2, the vehicle 10 includes a controller 11, a communication interface 12, a memory 13, a positioner 14, a detector 15, and an output interface 16.

The controller 11 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is, for example, a field-programmable gate array (FPGA), but is not limited to this. The dedicated circuit is, for example, an application specific integrated circuit (ASIC), but is not limited to this. The controller 11 controls operations of the entire vehicle 10.

The communication interface 12 includes at least one interface for communication for connecting to the network 40. The interface for communication is compliant with, for example, mobile communication standards such as the 4th generation (4G) standard or the 5th generation (5G) standard, but is not limited to these. In the present embodiment, the vehicle 10 communicates with the information processing apparatus 20 via the communication interface 12 and the network 40.

The memory 13 includes one or more memories. The memories are, for example, semiconductor memories, magnetic memories, optical memories, or the like, but are not limited to these. The memories included in the memory 13 may each function as, for example, a main memory, an auxiliary memory, or a cache memory. The memory 13 stores any information to be used for the operations of the vehicle 10. For example, the memory 13 may store a system program, an application program, embedded software, and the like. The information stored in the memory 13 may be updated with, for example, information acquired from the network 40 via the communication interface 12.

The positioner 14 includes a receiver compatible with a satellite positioning system. The receiver is compliant with, for example, the Global Positioning System (GPS), but is not limited to this, and may be compliant with any satellite positioning system. The positioner 14 includes, for example, a gyro sensor and a geomagnetic sensor. A car navigation apparatus, for example, may function as the positioner 14. In the present embodiment, the vehicle 10 can acquire a position of its own vehicle using the positioner 14.

The detector 15 includes a load sensor that detects an increase or decrease in the number of occupants of the vehicle 10. The load sensor may include, for example, a load sensor that detects an increase or decrease in the weight of occupants seated in vehicle seats or a load sensor that is attached to a suspension and detects an increase or decrease in a load, but is not limited to these. The detector 15 transmits a detection result of the load sensor to the controller 11.

The output interface 16 includes an interface for output that outputs information generated by the controller 11 or information read from the memory 13 to a user. The interface for output may be, for example, a panel display or a head-up display that outputs information in the form of images, a speaker that outputs information in the form of sound, or the like, but is not limited to these, and may be any interface. The output interface 16 outputs information acquired via the communication interface 12 to the user of the vehicle 10 by means of screen display, sound, or the like.

(Configuration of Information Processing Apparatus)

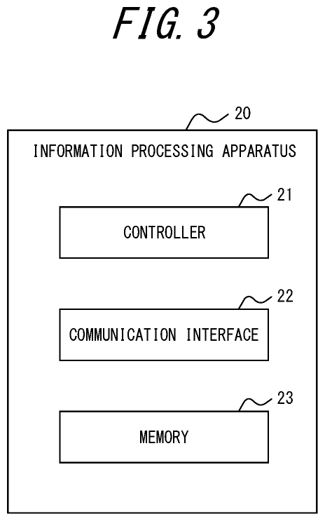

As illustrated in FIG. 3, the information processing apparatus 20 includes the controller 21, the communication interface 22, and a memory 23.

The controller 21 includes at least one processor, at least one programmable circuit, at least one dedicated circuit, or a combination of these. The controller 21 controls operations of the entire information processing apparatus 20.

The communication interface 22 includes at least one interface for communication for connecting to the network 40. The interface for communication is compliant with, for example, mobile communication standards, wired local area network (LAN) standards, or wireless LAN standards, but is not limited to these, and may be compliant with any communication standards. In the present embodiment, the information processing apparatus 20 communicates with the vehicles 10 via the communication interface 22 and the network 40.

The memory 23 includes one or more memories. The memories included in the memory 23 may each function as, for example, a main memory, an auxiliary memory, or a cache memory. The memory 23 stores any information to be used for the operations of the information processing apparatus 20. For example, the memory 23 may store a system program, an application program, a database, map information, and the like. The information stored in the memory 23 may be updated with, for example, information acquired from the network 40 via the communication interface 22.

(Configuration of Terminal Apparatus)

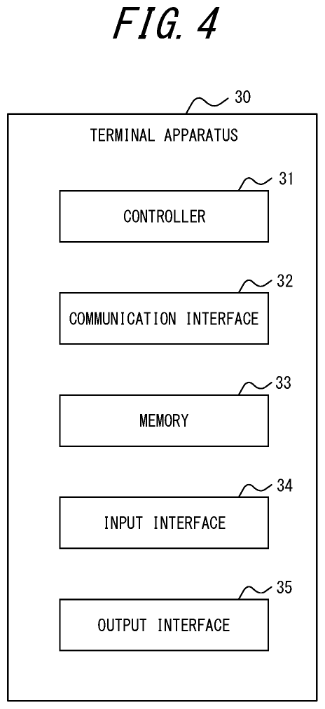

As illustrated in FIG. 4, the terminal apparatus 30 includes a controller 31, a communication interface 32, a memory 33, an input interface 34, and an output interface 35.

The controller 31 includes at least one processor, at least one programmable circuit, at least one dedicated circuit, or a combination of these. The controller 31 controls operations of the entire terminal apparatus 30.

The communication interface 32 includes at least one interface for communication for connecting to the network 40. The interface for communication is compliant with, for example, BLE (Bluetooth® (Bluetooth is registered trademark in Japan, other countries, or both) Low Energy), RFID (Radio Frequency Identification), LAN (Local Area Network), LTE (Long Term Evolution), 4G, or 5G, but is not limited to these, and may be compliant with any communication standards. In the present embodiment, the terminal apparatus 30 communicates with the information processing apparatus 20 via the communication interface 32 and the network 40.

The memory 33 includes one or more memories. The memories included in the memory 33 may each function as, for example, a main memory, an auxiliary memory, or a cache memory. The memory 33 stores any information to be used for the operations of the terminal apparatus 30. For example, the memory 33 may store a system program, an application program, a database, map information, and the like. The information stored in the memory 33 may be updated with, for example, information acquired from the network 40 via the communication interface 32.

The input interface 34 includes at least one interface for input. The interface for input may be, for example, a physical key, a capacitive key, a pointing device, a touch screen integrally provided with a display, or a microphone. The input interface 34 accepts an operation, such as a user input of information to be used for the operations of the terminal apparatus 30.

The output interface 35 includes at least one interface for output. The interface for output may be, for example, a display or a speaker. The display may be, for example, a liquid crystal display (LCD) or an organic electro luminescence (EL) display. The output interface 35 outputs information obtained by the operations of the terminal apparatus 30 to the user by means of screen display, sound, or the like.

(Flow of Operations of Information Processing Apparatus)

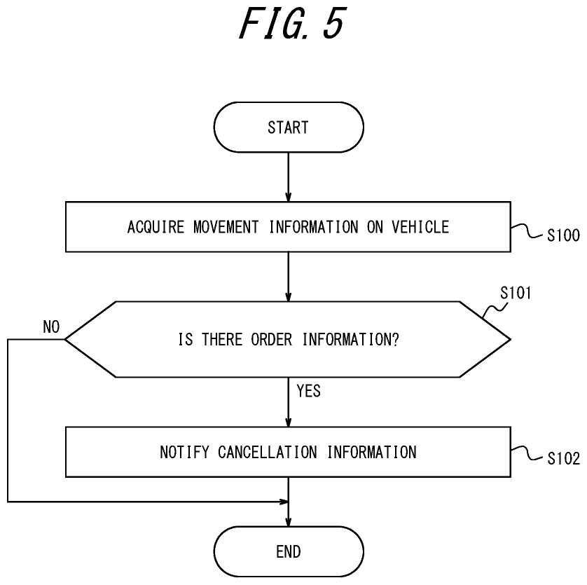

Operations of the information processing apparatus 20 according to the present embodiment will be described with reference to FIG. 5. These operations correspond to a method according to the present embodiment.

Here, suppose that users remaining in the vehicles 10 parked in the parking lot P attached to a commercial facility can order products or services in a delivery form from within the vehicles 10 to a provider of the products or services attached to the commercial facility using any user terminals or the like, while waiting for companions who are shopping at the commercial facility to return to the vehicles 10. The products may include, for example, fast food, drink, or the like, and the services may include, for example, shoe shining or the like, but are not limited to these. Suppose that identification information including names or the like of the users in the vehicles 10 is stored in advance in the memory 23 of the information processing apparatus 20. Also suppose that when the users in the vehicles 10 parked in the parking lot P order the products or services, the identification information including the names or the like of the users who have ordered the products or services and order information for the products or services are stored in association with each other in the memory 33 of the terminal apparatus 30 owned by the provider of the products or services. However, the present disclosure is not limited to these.

Step S100: The controller 21 of the information processing apparatus 20 acquires movement information on the vehicle 10-1 parked in the parking lot P.

Specifically, the movement information may include information indicating that the vehicle 10-1 has left the parking lot P. In this case, the controller 11 of the vehicle 10-1 generates the information indicating that the vehicle 10-1 has left the parking lot P, when the controller 11 determines that, for example, the vehicle 10-1 has passed through a gate provided at an entrance and exit of the parking lot P based on position information on the vehicle 10-1 acquired by the positioner 14. Then, the controller 11 of the vehicle 10-1 transmits, via the communication interface 12, the information indicating that the vehicle 10-1 has left the parking lot P to the information processing apparatus 20. Then, the controller 21 of the information processing apparatus 20 receives, via the communication interface 22, the information indicating that the vehicle 10-1 has left the parking lot P from the vehicle 10-1. In this way, the controller 21 of the information processing apparatus 20 can acquire the movement information on the vehicle 10-1 parked in the parking lot P. According to this, the provider of the products or services can get cancellation information for a product or service in step S102 described below. This avoids a situation in which a product or service is ordered but there is no recipient of the product or service.

The movement information may also include information indicating that the vehicle 10-1 has departed from a parking space S that the parking lot P has. In this case, the controller 11 of the vehicle 10-1 generates the information indicating that the vehicle 10-1 has departed from the parking space S that the parking lot P has, when the controller 11 determines that the vehicle 10-1 has departed from the parking space S that the parking lot P has, based on the position information on the vehicle 10-1 acquired by the positioner 14. Then, the controller 11 of the vehicle 10-1 transmits, via the communication interface 12, the information indicating that the vehicle 10-1 has departed from the parking space S that the parking space P has, to the information processing apparatus 20. Then, the controller 21 of the information processing apparatus 20 receives, via the communication interface 22, the information indicating that the vehicle 10-1 has departed from the parking space S that the parking space P has, from the vehicle 10-1. In this way, the controller 21 of the information processing apparatus 20 can acquire the movement information on the vehicle 10-1 parked in the parking lot P. According to this, the provider of the products or services can get the cancellation information for a product or service as soon as possible in step S102 described below. This means that the provider of the products or services need not start preparing a product or service ordered by the user in the vehicle 10-1.

The movement information may also include information indicating a change in a shift lever position of the vehicle 10-1. For example, when the shift lever position of the vehicle 10-1 changes from a position of a parking range “P” to a position of a forward range “D”, the vehicle 10-1 is determined to be just before moving. In this case, when the controller 11 of the vehicle 10-1 detects the change in the shift lever position of the vehicle 10-1, the controller 11 generates the information indicating the change in the shift lever position of the vehicle 10-1. The controller 11 of the vehicle 10-1 then transmits, via the communication interface 12, the information indicating the change in the shift lever position of the vehicle 10-1 to the information processing apparatus 20. Then, the controller 21 of the information processing apparatus 20 receives, via the communication interface 22, the information indicating the change in the shift lever position of the vehicle 10-1 from the vehicle 10-1. In this way, the controller 21 of the information processing apparatus 20 can acquire the movement information on the vehicle 10-1 parked in the parking lot P. According to this, the provider of the products or services can get the cancellation information for a product or service as soon as possible in step S102 described below. This means that the provider of the products or services need not start preparing a product or service ordered by the user in the vehicle 10-1.

The movement information may also include information indicating an increase in the number of occupants of the vehicle 10-1. For example, when the number of occupants of the vehicle 10-1 increases as the companion who has been shopping at the commercial facility returns to the vehicle 10-1, the vehicle 10-1 is determined to be just before moving. In this case, when the controller 11 of the vehicle 10-1 detects the increase in the number of occupants of the vehicle 10-1 by the detector 15, the controller 11 generates the information indicating the increase in the number of occupants of the vehicle 10-1. Then, the controller 11 of the vehicle 10-1 transmits, via the communication interface 12, the information indicating the increase in the number of occupants of the vehicle 10-1 to the information processing apparatus 20. Then, the controller 21 of the information processing apparatus 20 receives, via the communication interface 22, the information indicating the increase in the number of occupants of the vehicle 10-1 from the vehicle 10-1. In this way, the controller 21 of the information processing apparatus 20 can acquire the movement information on the vehicle 10-1 parked in the parking lot P. According to this, the provider of the products or services can get the cancellation information for a product or service as soon as possible in step S102 described below. This means that the provider of the products or services need not start preparing a product or service ordered by the user in the vehicle 10-1.

In the present disclosure, a method by which the controller 21 of the information processing apparatus 20 acquires the movement information on the vehicle 10-1 parked in the parking lot P is not limited to the examples described above. For example, the controller 21 of the information processing apparatus 20 may acquire the movement information on the vehicle 10-1 parked in the parking lot P using any image recognition technology from video of any surveillance camera provided in the parking lot P, any in-vehicle camera provided in the vehicle 10-1, or the like.

Step S101: The controller 21 of the information processing apparatus determines whether there is order information for a product or service ordered by the user of the vehicle 10-1. In a case in which the controller 21 determines that there is such order information (step S101-Yes), the process proceeds to step S102. On the other hand, in a case in which the controller 21 determines that there is no such order information (step S101-No), the process ends.

Specifically, the controller 21 of the information processing apparatus 20 identifies the user in the vehicle 10-1 relating to the movement information acquired in step S100, with reference to the memory 23. Then, the controller 21 of the information processing apparatus 20 inquires of the terminal apparatus 30 whether there is order information for a product or service ordered by the identified user. Then, the controller 31 of the terminal apparatus 30 responds, to the information processing apparatus 20, whether there is order information for a product or service ordered by the identified user, with reference to the memory 33 in which the identification information on the users who have ordered the products or services and the order information for the products or services are stored in association with each other. Then, the controller 21 of the information processing apparatus 20 determines, based on the content of the response from the terminal apparatus 30, whether there is order information for the product or service ordered by the user in the vehicle 10-1.

Step S102: The controller 21 of the information processing apparatus 20 notifies the provider of the products or services of cancellation information for the product or service ordered by the user of the vehicle 10-1 parked in the parking lot P.

Specifically, the controller 21 of the information processing apparatus 20 generates cancellation information for the product or service ordered by the user in the vehicle 10-1 based on the content of the response from the terminal apparatus 30. Then, the controller 21 of the information processing apparatus 20 transmits, via the communication interface 22, the generated cancellation information for the product or service to the terminal apparatus 30. Then, the controller 31 of the terminal apparatus 30 receives the cancellation information for the product or service from the information processing apparatus 20 via the communication interface 32. Then, the controller 31 of the terminal apparatus 30 outputs the cancellation information for the product or service to a shop assistant or the like by screen display, sound, or the like via the output interface 35. The cancellation information includes the name of the product or service that has been ordered by the user in the vehicle 10-1, but is not limited to this.

As described above, when the controller 21 of the information processing apparatus 20 according to the present embodiment acquires movement information on the vehicle 10-1 parked in the parking lot P, the controller 21 determines whether there is order information for a product or service ordered by the user of the vehicle 10-1. In a case in which there is order information for the product or service, the controller 21 of the information processing apparatus 20 notifies, via the communication interface 22, the provider of the products or services of cancellation information for the product or service.

According to such a configuration, when the vehicle 10-1 parked in the parking lot P moves, the cancellation information for the product or service that has been ordered by the user of the vehicle 10-1 is notified to the provider of the products or services. This avoids a situation in which a product or service is ordered but there is no recipient of the product or service. Thus, technology for improving efficiency of operations in stores that provide products or services is improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

As a variation, the configuration and operations of the information processing apparatus 20 in the above embodiment may be distributed to a plurality of computers capable of communicating with each other. For example, an embodiment in which some or all of the components of the information processing apparatus 20 are provided in the vehicles 10 can also be implemented. For example, a car navigation device mounted on the vehicles 10 may be provided with some or all components of the information processing apparatus 20.

As a variation, the controller 21 of the information processing apparatus 20 may notify, via the communication interface 22, the other vehicles 10-2, 10-3, and 10-4 located in the parking lot P of sale information on the product or service canceled by the user of the vehicle 10-1 parked in the parking lot P. In this case, when the controllers 11 of the other vehicles 10-2, 10-3, and 10-4 each receive the sale information from the information processing apparatus 20 via the communication interfaces 12, the controllers 11 each output the received sale information via the output interfaces 16 to the users in the other vehicles 10-2, 10-3, and 10-4 by screen display, sound, or the like. The sale information may include the name of the product or service, the name of the provider of the product or service, an offer price for the product or service, or an offer deadline for the product or service, but is not limited to these. This can reduce food loss and other waste, when any of the users in the other vehicles 10-2, 10-3, and 10-4 orders the product or service included in the sale information. The controller 21 of the information processing apparatus 20 may display the sale information in pop-up on arbitrary user terminals or the like owned by the users in the other vehicles 10-2, 10-3, and 10-4.

As a variation, when a predetermined time has elapsed since the notification of the above-described sale information, the controller 21 of the information processing apparatus 20 may notify, via the communication interface 22, the other vehicles 10-2, 10-3, and 10-4 of discount information for promoting the sale of the product or service. The discount information may include a discount price or a discount rate for the product or service determined by the controller 21 of the information processing apparatus 20 in accordance with the elapsed time, but is not limited to this.

As a variation, the controller 21 of the information processing apparatus 20 may notify, via the communication interface 22, the vehicle 10-1 of the cancellation information of the above-described step S102. This notification allows the user in the vehicle 10-1 to know that the product or service that the user himself or herself has ordered is automatically cancelled, so that the user need not cancel the order by himself or herself, thereby reducing a psychological burden.

As a variation, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing apparatus comprising a controller and a communication interface, the controller configured to:
upon acquiring movement information on a vehicle parked in a parking lot, determine whether there is order information for a product or service ordered by a user of the vehicle; and
in a case in which there is order information for the product or service, notify, via the communication interface, a provider of the product or service of cancellation information for the product or service.

2. The information processing apparatus according to claim 1, wherein the movement information includes information indicating that the vehicle has left the parking lot.

3. The information processing apparatus according to claim 1, wherein the movement information includes information indicating that the vehicle has departed from a parking space that the parking lot has.

4. The information processing apparatus according to claim 1, wherein the movement information includes information indicating a change in a shift lever position of the vehicle.

5. The information processing apparatus according to claim 1, wherein the movement information includes information indicating an increase in number of occupants of the vehicle.

6. The information processing apparatus according to claim 1, wherein the controller is configured to notify, via the communication interface, another vehicle located in the parking lot of sale information for the product or service canceled by the user.

7. The information processing apparatus according to claim 1, wherein the controller is configured to notify the vehicle of the cancellation information via the communication interface.

8. A method performed by an information processing apparatus, comprising:
upon acquiring movement information on a vehicle parked in a parking lot, determining whether there is order information for a product or service ordered by a user of the vehicle; and
in a case in which there is order information for the product or service, notifying a provider of the product or service of cancellation information for the product or the service.

9. The method according to claim 8, wherein the movement information includes information indicating that the vehicle has left the parking lot.

10. The method according to claim 8, wherein the movement information includes information indicating that the vehicle has departed from a parking space of the parking lot.

11. The method according to claim 8, wherein the movement information includes information indicating a change in a shift lever position of the vehicle.

12. The method according to claim 8, wherein the movement information includes information indicating an increase in number of occupants of the vehicle.

13. The method according to claim 8, further comprising notifying another vehicle located in the parking lot of sale information for the product or service canceled by the user.

14. The method according to claim 8, further comprising notifying the vehicle of the cancellation information.

15. A non-transitory computer readable medium storing a program configured to cause a computer to execute operations, the operations comprising:
upon acquiring movement information on a vehicle parked in a parking lot, determining whether there is order information for a product or service ordered by a user of the vehicle; and
in a case in which there is order information for the product or service, notifying a provider of the product or service of cancellation information for the product or service.

16. The non-transitory computer readable medium according to claim 15, wherein the movement information includes information indicating that the vehicle has left the parking lot.

17. The non-transitory computer readable medium according to claim 15, wherein the movement information includes information indicating that the vehicle has departed from a parking space of the parking lot.

18. The non-transitory computer readable medium according to claim 15, wherein the movement information includes information indicating a change in a shift lever position of the vehicle.

19. The non-transitory computer readable medium according to claim 15, wherein the movement information includes information indicating an increase in number of occupants of the vehicle.

20. The non-transitory computer readable medium according to claim 15, wherein the operations further comprise notifying another vehicle located in the parking lot of sale information for the product or service cancelled by the user.
